(19) United States
(12) Patent Application Publication
(10) Pub. No.: US 2016/0268965 A1
(43) Pub. Date: Sep. 15, 2016

(54) MOUNTING BRACKET ASSMEBLY

(71) Applicant: Vermont Slate & Copper Services, Inc., Morrisville, VT (US)

(72) Inventors: Brian Cecil Stearns, Stowe, VT (US); Alexander Grant Bornemann, Wolcott, VT (US)

(21) Appl. No.: 15/066,920

(22) Filed: Mar. 10, 2016

Related U.S. Application Data
(60) Provisional application No. 62/177,348, filed on Mar. 10, 2015.
(60) Provisional application No. 62/259,138, filed on Nov. 24, 2015.

(51) Int. Cl. H02S 40/34; H02S 40/32; H02S 20/00; F16M 13/02

(52) U.S. Cl. CPC H02S 40/34; F16M 13/02; H02S 40/32; H02S 20/00; F16B 2001/0064

(57) ABSTRACT

The present disclosure relates to mounting brackets. In various embodiments, a mounting bracket may comprise a middle portion, a top portion, and a bottom portion. The middle portion may comprise a channel and a lip. The top portion may be operatively coupled to the middle portion. The top portion may comprise a first engagement structure. The top portion may also define a first aperture. The bottom portion may be operatively coupled to the middle portion. The mounting bracket may be configured to mount a container to a structure. The mounting bracket may also be configured to create a bond path between the container and the structure.

### CROSS REFERENCE TO RELATED APPLICATIONS

This application claims priority to and the benefit of U.S. Provisional Application 62/177,348, filed on Mar. 10, 2015 and entitled Hardware and wire clip for solar panels, which is incorporated herein by reference in its entirety for all purposes. This application also claims priority to and the benefit of U.S. Provisional Application 62/259,138, filed on Nov. 24, 2015 and entitled MOUNTING BRACKET ASSEMBLY, which is incorporated herein by reference in its entirety for all purposes.

### FIELD

The present disclosure relates to brackets for mounting elements on structures. In particular, the disclosure relates to mounting brackets for solar panels. In some embodiments, the disclosure may relate to mounting containers to solar panels, the containers capable of supporting or holding AC-DC power converters, wires, and the like.

### BACKGROUND

Within the solar industry there is often a need to attach devices such as, for example, electrical inverters, wire management devices, plumbing pipes, electrical grounding cables and/or the like to solar panels. There are a variety of “snap in place” clips that are used for wire management alone. However, these clips are designed to accommodate and/or support wires. Moreover, there is no common solution for attaching accessories to solar panels.

### SUMMARY

The present disclosure relates to mounting brackets. In various embodiments, a mounting bracket may comprise a middle portion, a top portion, and a bottom portion. The middle portion may comprise a channel and a lip. The top portion may be operatively coupled to the middle portion. The top portion may comprise a first engagement structure. The top portion may also define a first aperture. The bottom portion may be operatively coupled to the middle portion. The mounting bracket may be configured to mount a container to a structure. The mounting bracket may also be configured to create a bond path between the container and the structure.

In various embodiments, the bottom portion may comprise a second engagement structure. The bottom portion may also define a second aperture. The first aperture may be substantially concentric with the second aperture.

In various embodiments, the first engagement structure may be a tooth. The first engagement structure may be a textured surface. The first engagement structure may also be a fastener.

In various embodiments, the middle portion may be operatively coupled to the top portion by a first bend. The bottom portion may be a lip. The bottom portion may be operatively coupled to the middle portion by a second bend.

In various embodiments, the bottom portion comprises a second engagement structure. The second engagement structure may be a tooth, a fastener, or a textured surface.

In various embodiments, an inverter clip may comprise a first member, a second member, and a third member. The first member may define a channel and a lip. The second member may be operatively coupled to and disposed above the first member. The second member may comprise a first tooth. The second member may also define a first aperture. The third member may be operatively coupled to and disposed below the first member. The third member may comprise a second tooth. The third member may define a second aperture. The inverter clip may be configured to create a bond path between a solar panel and a container.

In various embodiments, the first member may be coupled to the second member by a first bend. The first member may be coupled to the third member by a second bend. A portion of the second member may extends beyond the second bend. In this regard, the second bend is disposed between the first bend and the lip.

In various embodiments, the first member may be operatively coupled to the second member by a hinge pin.

In various embodiments, the first tooth may be configured to engage a metal portion of a frame of the solar panel.

In various embodiments, the first aperture may be concentric with the second aperture. A fastener may be installable through the first aperture and the second aperture to compress the second member and the third member toward the first member.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 shows an exploded perspective view of first mounting bracket assembly with a first bracket body configuration, in accordance with various embodiments;

FIG. 2 shows a perspective view of the first mounting bracket assembly with the first bracket body configuration, in accordance with various embodiments;

FIG. 3 shows an exploded perspective view of the first mounting bracket assembly with the first bracket body configuration, in accordance with various embodiments;

FIG. 4 shows an exploded side view of the first mounting bracket assembly with the first bracket body configuration, in accordance with various embodiments;

FIG. 5 shows a side view of the first mounting bracket assembly with the first bracket body configuration in a first assembled configuration, in accordance with various embodiments;

FIG. 6 shows a side view of the first mounting bracket assembly with the first bracket body configuration in a second assembled configuration, in accordance with various embodiments;

FIGS. 7A-7G show side and bottom views of the first mounting bracket assembly with the first bracket body configuration in various states of assembly relative to a container and a frame member of a structure, in accordance with various embodiments;

FIG. 8 shows a perspective view of the first mounting bracket assembly with a second bracket body configuration, in accordance with various embodiments;

FIG. 9 shows a side view of a second mounting bracket assembly, in accordance with various embodiments;

FIG. 10 shows a first perspective view of the second mounting bracket assembly, in accordance with various embodiments;

FIG. 11 shows a second perspective view of the second mounting bracket assembly, in accordance with various embodiments;

FIG. 12 shows a third perspective view of the second mounting bracket assembly, in accordance with various embodiments;

FIG. 13 shows an exploded perspective view of third mounting bracket assembly with a first bracket body configuration, in accordance with various embodiments;

FIG. 14 shows a perspective view of a portion of the third mounting bracket assembly with the first bracket body configuration, in accordance with various embodiments;

FIG. 15 shows a perspective view of the third mounting bracket assembly with the first bracket body configuration, in accordance with various embodiments;

FIG. 16 shows a cross-sectional view of the third mounting bracket assembly with the first bracket body configuration, in accordance with various embodiments;

FIG. 17 shows a side view of the third mounting bracket assembly with the first bracket body configuration installed on a frame member of a structure with a container, in accordance with various embodiments;

FIG. 18 shows an exploded perspective view of third mounting bracket assembly with a second bracket body configuration including a wire management structure, in accordance with various embodiments;

FIG. 19 shows a perspective view of a portion of the third mounting bracket assembly with the second bracket body configuration, in accordance with various embodiments;

FIG. 20 shows a perspective view of the third mounting bracket assembly with the second bracket body configuration, in accordance with various embodiments;

FIG. 21 shows a cross-sectional view of the third mounting bracket assembly with the second bracket body configuration, in accordance with various embodiments;

FIG. 22 shows a side view of the third mounting bracket assembly with the second bracket body configuration installed on a frame member of a structure with a container, in accordance with various embodiments;

FIG. 23A shows an exploded perspective view of a solar panel mounting system with a fourth mounting assembly attachable to a container, in accordance with various embodiments;

FIG. 23B shows a perspective view of a solar panel mounting system with the fourth mounting assembly that is attached to a container, in accordance with various embodiments;

FIG. 24 shows a top view of a solar panel mounting system with the fourth mounting assembly that is attached to a container, in accordance with various embodiments;

FIG. 25 shows a side view of a solar panel mounting system with the fourth mounting assembly that is attached to a container, in accordance with various embodiments;

FIG. 26 shows a perspective view of a solar panel mounting system with the fourth mounting assembly attachable to a container, in accordance with various embodiments;

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

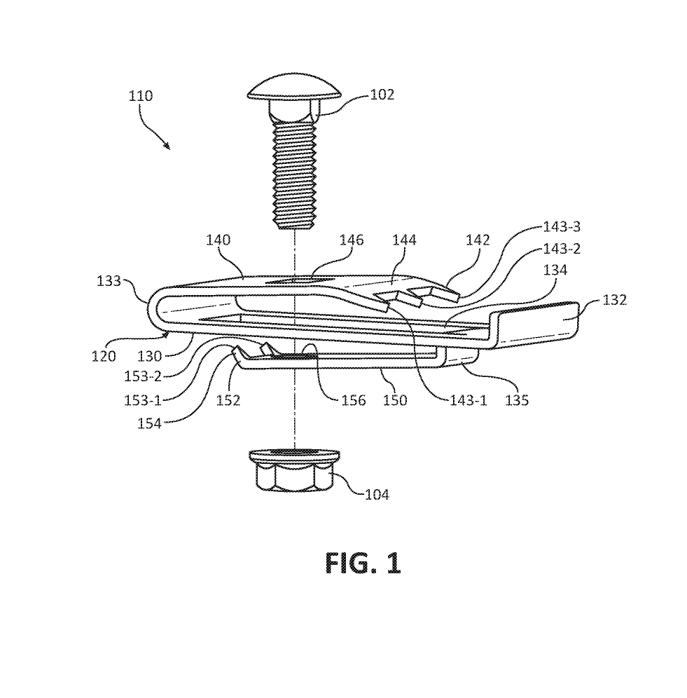

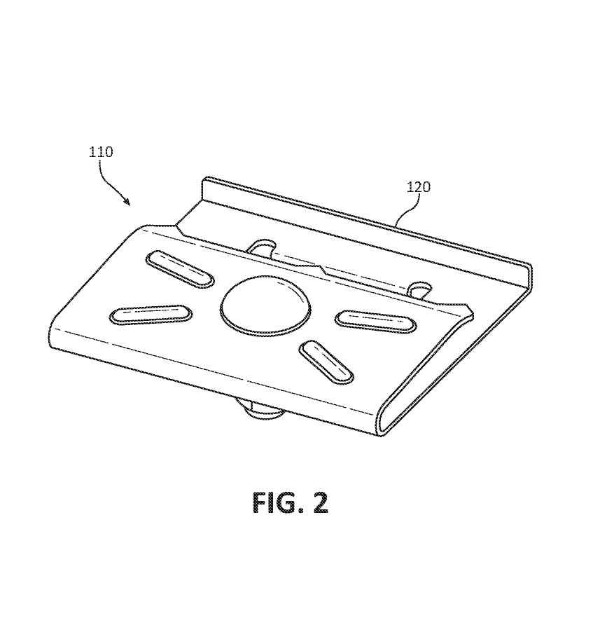

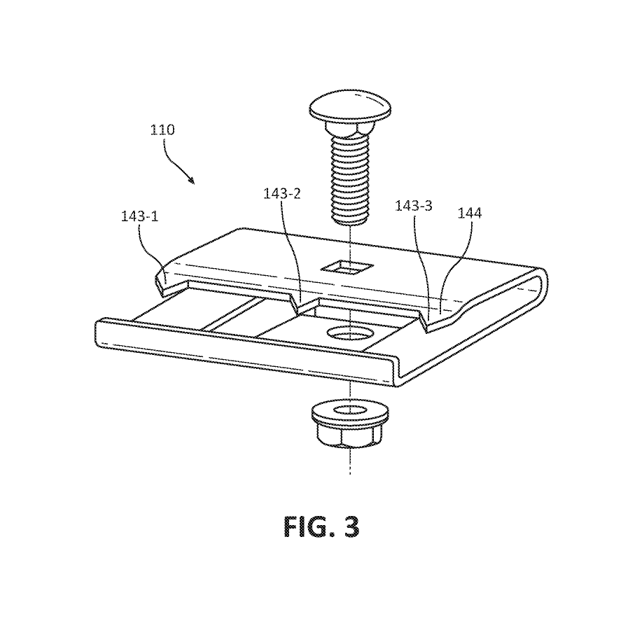

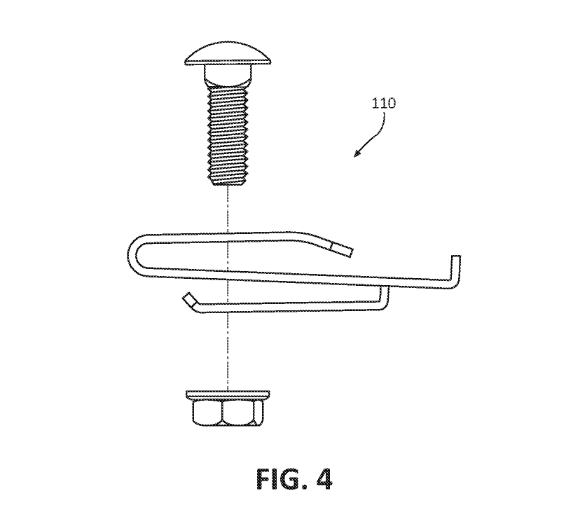

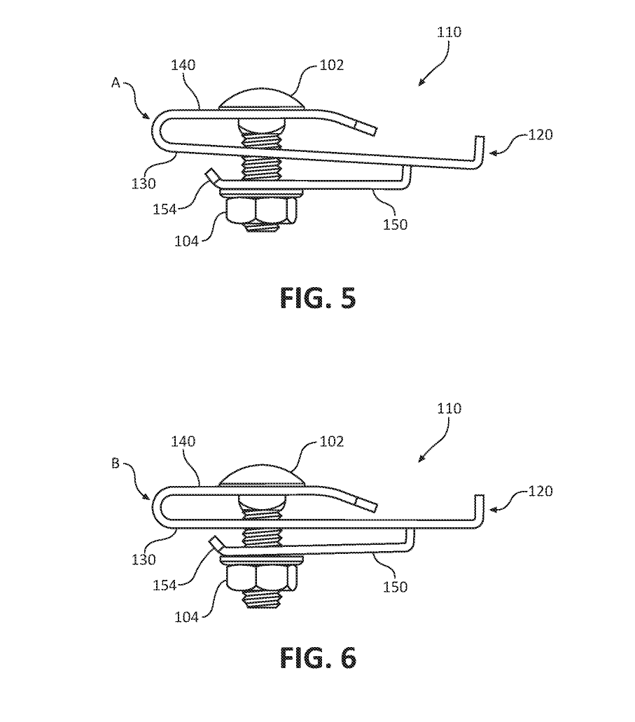

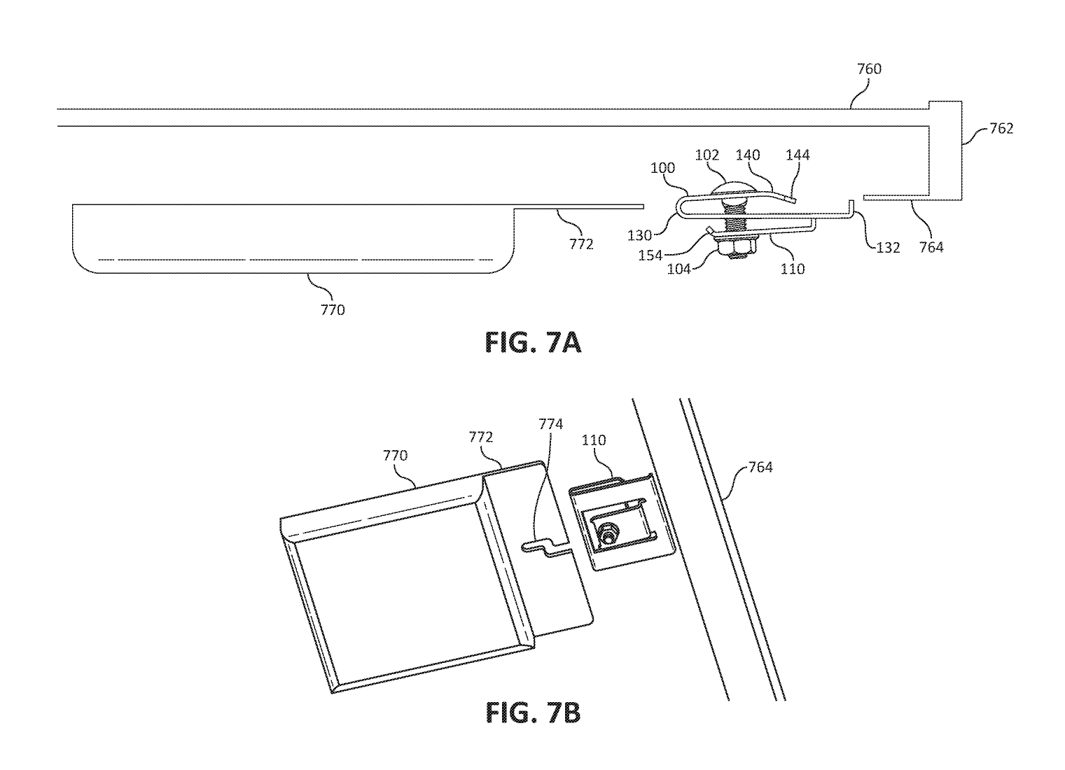

In various embodiments and with reference to FIGS. 1-6, a mounting bracket assembly 110 (e.g., an inverter clip) is provided. Mounting bracket assembly 110 may include a mounting bracket 120, a fastener 102 (e.g., a bolt), and a retaining element 104 (e.g., a nut). Mounting bracket 120 may have an S-shape. In this regard, mounting bracket 120 may comprise an upper portion 140 (e.g., a top portion, a second portion, second member, and/or the like), a middle portion 130 (e.g., a first portion, a first member, and/or the like), and a lower portion 150 (e.g., a bottom portion, a third portion, a third member, and/or the like). Upper portion 140, middle portion 130 and lower portion 150 may be disposed substantially parallel to one another. In this regard, middle portion 130 may be disposed between upper portion 140 and lower portion 150. Upper portion 140 may be operatively coupled with and/or attached to middle portion 130 at a first bend 133. Middle portion 130 may also be operatively coupled with and/or attached to lower portion 150 at a second bend 135. Middle portion 130 may extend beyond second bend 135.

Middle portion 130 may include a lip 132. Lip 132 may define a foremost edge of mounting bracket 120. Lip 132 may be integrally formed in middle portion 130. In this regard, lip 132 may be formed or bent as a portion or end of middle portion 130. Lip 132 may also be operatively coupled to middle portion 130.

In various embodiments, first bend 133 may be pliable, moveable, deformable (e.g., elastically deformable or plastically deformable) and/or the like. In this regard, end 142 of the upper portion 140 (i.e., the end of the upper portion 140 opposite first bend 133) may move relative to the middle portion 130 in response to first bend 133 being moved. In this regard, and in response to first bend 133 being loaded, end 142 may contact middle portion 130. Second bend 135 may be similarly pliable, moveable, deformable (e.g., elastically deformable or plastically deformable) and/or the like. In this regard, end 152 of the lower portion 150 (i.e., the end of the lower portion 150 opposite second bend 135) may move relative to the middle portion 130 in response to second bend 135 being moved. In this regard, and in response to second bend 135 being loaded, end 142 may contact middle portion 130.

End 142 of the upper portion 140 may include an engagement structure 144. Engagement structure 144 may be configured to removably couple accessories (e.g., junction boxes, wire management structures, sensors, voltage management equipment, and/or the like) to a structure (e.g., a solar panel or a solar panel mounting system). Engagement structure 144 may also be configured to create an electrically conductive path (e.g., a bond path) between a metal structure, a container, and at least a portion of mounting bracket assembly 110. Engagement structure 144 may be any suitable structure for creating an electrically conductive path. Engagement structure 144 may also be configured to pierce or otherwise penetrate a coating on the metal structure. Engagement structure 144 may also be any suitable structure that is configured to sufficiently engage a metal structure and support a container such as, for example, in a cantilevered configuration. Engagement structure 144 may include one or more teeth including, for example, tooth 143-1, tooth 143-2, and tooth 143-3, and/or the like. In this regard, that shape, type and/or style of engagement structure 144 may be defined based on the width of the mounting bracket 120, the size of the various engagement structures such as, for example, the spacing between adjacent teeth. Engagement structure 144 may also be for example, a fastener, one or more conductive pins and/or the like. Upper portion 140 may be substantially planar, though the teeth at the end 142 extend downwards towards middle portion 130. Similarly, end 152 of the lower portion 150 may include one of more teeth such as, for example, tooth 153-1, tooth 153-2, and/or the like. Lower portion 150 may be substantially planar, though the teeth at the end 152 extend upwards towards the middle portion 130.

In various embodiments, each of upper portion 140, middle portion 130, and lower portion 150 may include apertures extending there through. Upper portion 140 may include an aperture 146 that is sized and shaped to retain, capture, and/or hold at least a portion of a fastener 102. For example, aperture 146 may be a square aperture which is sized to accept a square shoulder or neck of fastener 102 (e.g., where fastener 102 is a carriage bolt) located directly below the head. Middle portion 130 may include a channel 134 which extends between first bend 133 to second bend 135 along a portion of and/or along substantially the entire length of middle portion 130. The channel 134 may be aligned with the aperture 146 in upper portion 140. In this regard, fastener 102, which passes through the aperture 146, may also be capable of passing through the channel 134. Aperture 156 in the lower portion 150 may be sized to accept a portion of fastener 102 (e.g., the shaft of fastener 102). Aperture 156 may also be aligned with aperture 146 and channel 134. In this regard, fastener 102, which passes through the aperture 146 and channel 134, may also be capable of passing through the aperture 156.

In various embodiments and as shown in FIGS. 1-7G, mounting bracket 120 may be a single, unitary component formed by stamping. Mounting bracket 120 may also be formed by any other manufacturing processes. Channel 134 may be formed by cutting or stamping middle portion 130 around free sides of the lower portion 150 and deforming the lower portion 150 out of the plane of the middle portion 130. The teeth 143 and teeth 153 and the lip 132 are also bent out of the plane of the respective upper portion 140, lower portion 150, and/or middle portion 130.

In various embodiments and with particular reference to FIGS. 1 and 5-6, in operation, mounting bracket 120 may be compressed from a first position A to a second position B in response to retaining element 104 being coupled to fastener 102. In this regard, upper portion 140 and lower portion 150 can be attached to the middle portion 130 at opposing ends via first bend 133 and second bend 135. In response to fastener 102 being placed through aperture 146, aperture 156, and channel 134, and retaining element 104 (e.g., a nut) being tightened, ends 142, 152 may be moved toward middle portion 130. Teeth 143 and teeth 153 located at ends 142 and 152, respectively, may be hardened such that they are capable of biting into non-hardened metal or penetrating metal coatings (e.g., anodize coating).

In various embodiments and with reference to FIGS. 1-7G, teeth 143 located at end 142 of upper portion 140 can bite into a tab 764 of a frame 762 of a solar panel 760. Similarly, teeth 153 located at end 152 of lower portion 150 can bite into a lip 772 of a container 770 configured to hold, for example, an AC-DC power adaptor, thereby fixing the AC-DC power adaptor to the frame 762. Alternatively, the container may simply be the housing of the AC-DC power adaptor.

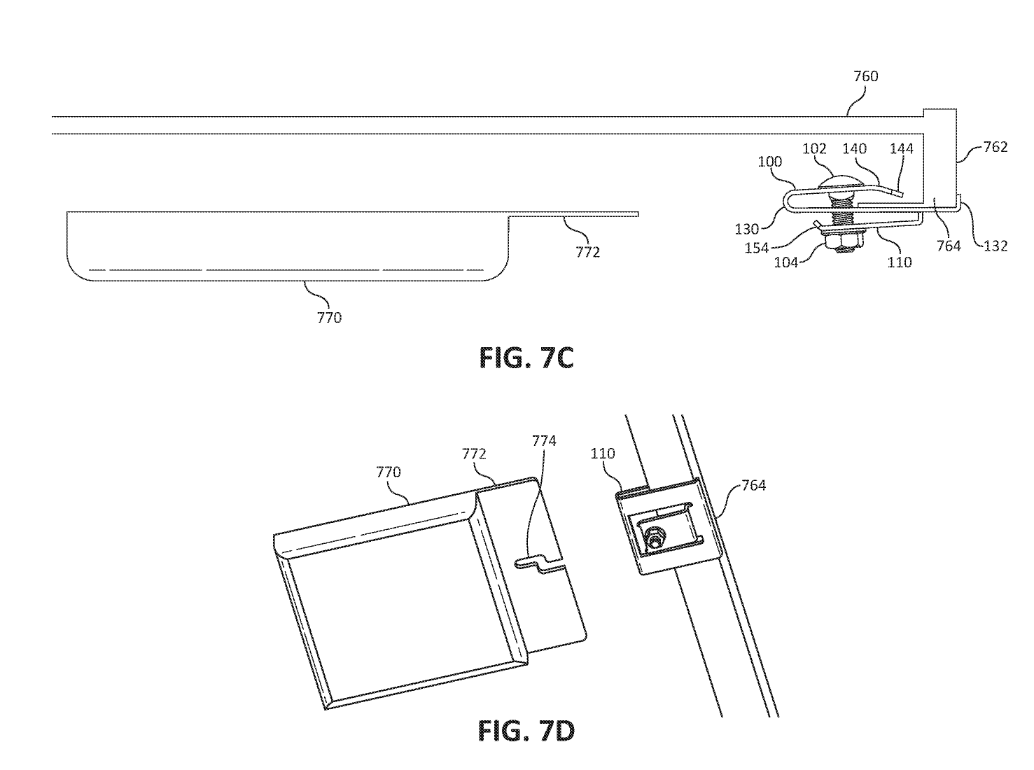

In various embodiments and with reference to FIGS. 7A-7G, the lip 772 may include a slot 774 configured to receive the fastener 102. The illustrated slot 774 includes a jog. Mounting bracket 120 may be made of any an electrically conducting material, such as metal. Mounting bracket 120 may be configured to electrically ground the adaptor to the frame 762 via teeth 143 engaging and cutting into the tab 764 and the teeth 153 engaging and cutting into the lip 772.

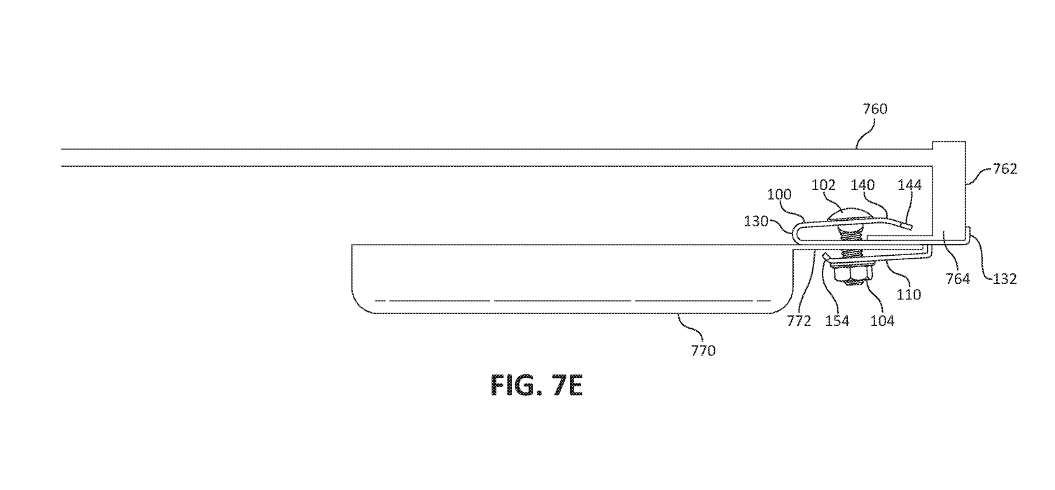

In various embodiments and with reference to FIG. 8, mounting bracket assembly 810 may include mounting bracket 820 comprising multiple pieces. For example, mounting bracket 820 may include a first bracket portion 822 and a second bracket portion 824. First bracket portion 822 and second bracket portion 824 may be operatively coupled to one another. For example, first bracket portion 822 and second bracket portion 824 may be coupled to one another in a hinged arrangement. In this regard, mounting bracket assembly 810 may further comprise a hinge pin 826. Hinge pin 826 may be configured engage and/or pass through portions of first bracket portion 822 and second bracket portion 824 to create mounting bracket assembly 810. Moreover, the hinge joint may allow first bracket portion 822 and/or second bracket portion 824 to be moveable with respect to one another as described herein and/or with respect to other structure of the mounting bracket assemblies described herein.

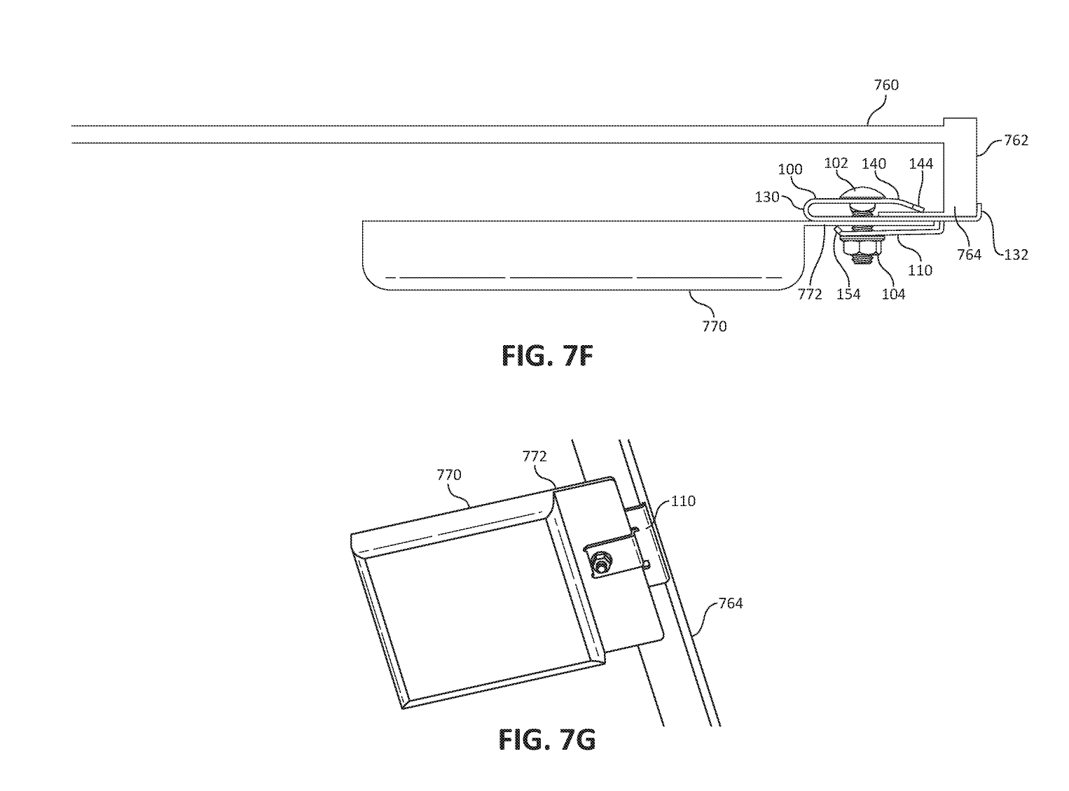

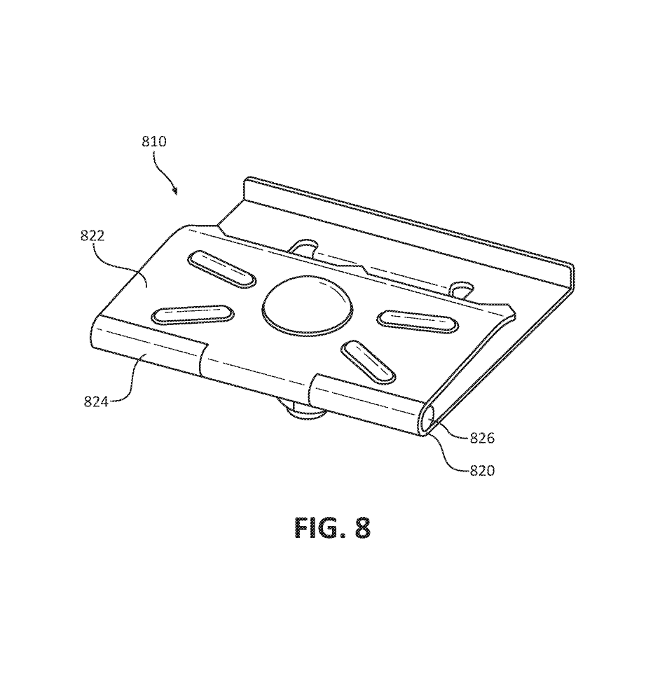

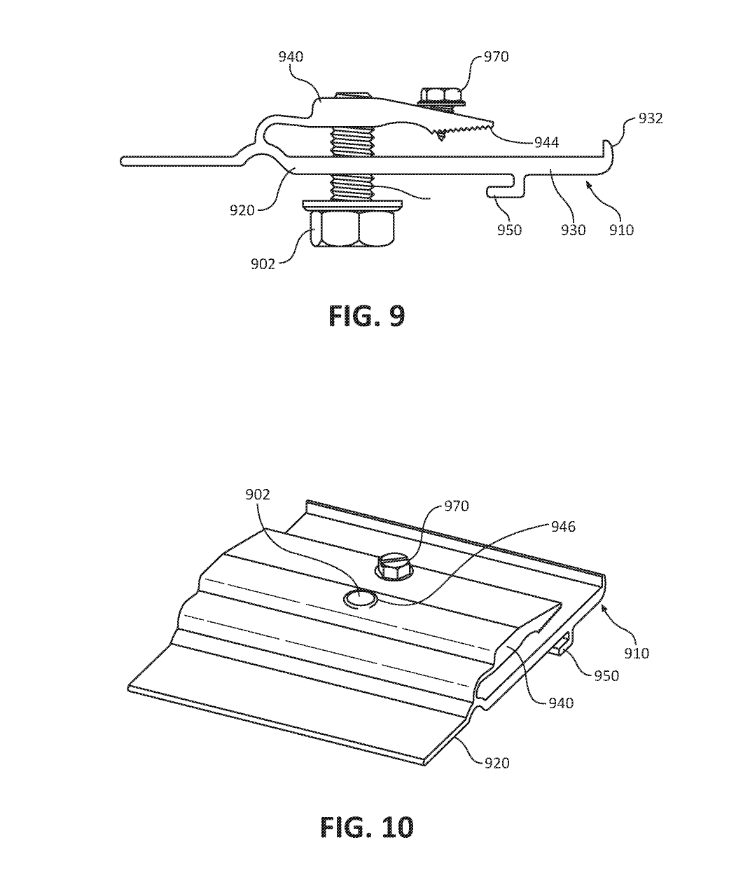

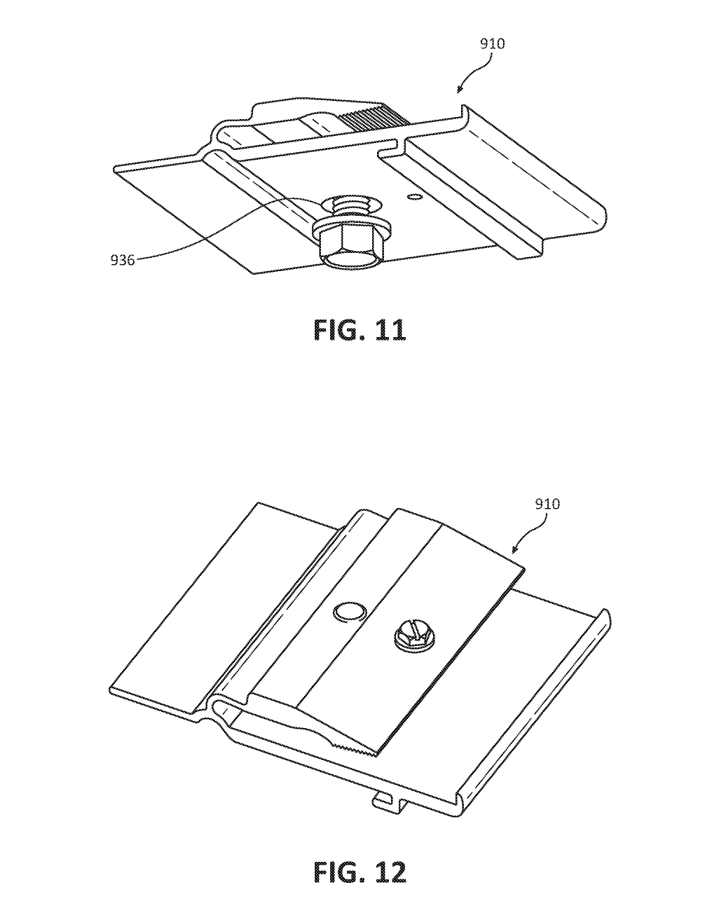

In various embodiments and with reference for FIGS. 9-12, mounting bracket assembly 910 may comprise mounting bracket 920 including a middle portion 930, an upper portion 940 and a lower catch portion 950. Mounting bracket 920 may be configured to receive and retainer a fastener 902. In this regard, upper portion 940 may include a threaded aperture 946. Threaded aperture 946 may be configured to receive and retain at least a portion of the threaded shaft of fastener 902. Moreover, middle portion 930 may comprise an aperture 936 that is aligned with threaded aperture 946. In this regard, fastener 902 may pass through aperture 936 and engage or be installed in threaded aperture 946.

In operation, mounting bracket 920 may be installable on the frame of a structure (e.g. a tab 764 of solar panel 760 as shown in FIGS. 7A-7G). In this regard, mounting bracket assembly 910 may be positioned on the tab such that the tab is disposed between middle portion 930 and upper portion 940. In response to fastener 902 being threaded into threaded aperture 946, middle portion 930 and upper portion 940 may compress on and/or capture at least a portion of the tab. For example, upper portion 940 may comprise a textured or toothed surface 944 that may engage and/or operatively couple with the tab. Moreover, lip 932 or middle portion 930 may capture and end of the frame to secure mounting bracket assembly 910 to the frame.

In various embodiments, mounting bracket 920 may be made of a relatively soft metal as compared to the frame of the structures described herein. For example, mounting bracket 920 may be made of aluminum. In this regard, textured surface 944 may not sufficiently engage the frame to create an electrically conductive path (e.g., a bond path). To create this electrically conductive path, mounting bracket assembly 910 may include a bonding fastener 970. Bonding fastener 970 may be any suitable fastener (e.g., a steel or stainless steel fastener) that can create a bond path between the frame and mounting bracket assembly 910. In this regard, bonding fastener 970 may be configured to engage the frame and/or penetrate any coating on the frame to create an electrically conductive path between the frame and mounting bracket 920.

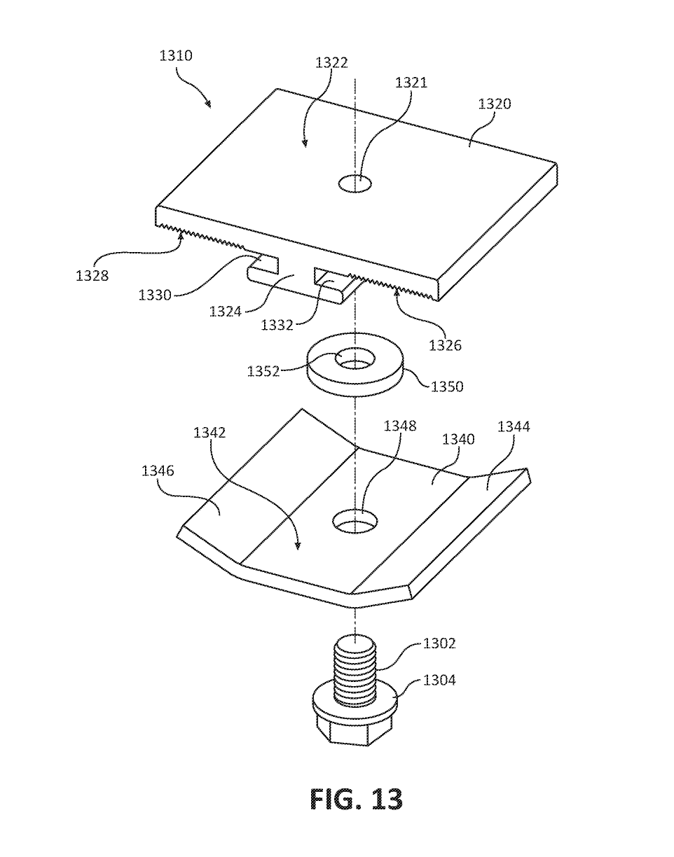

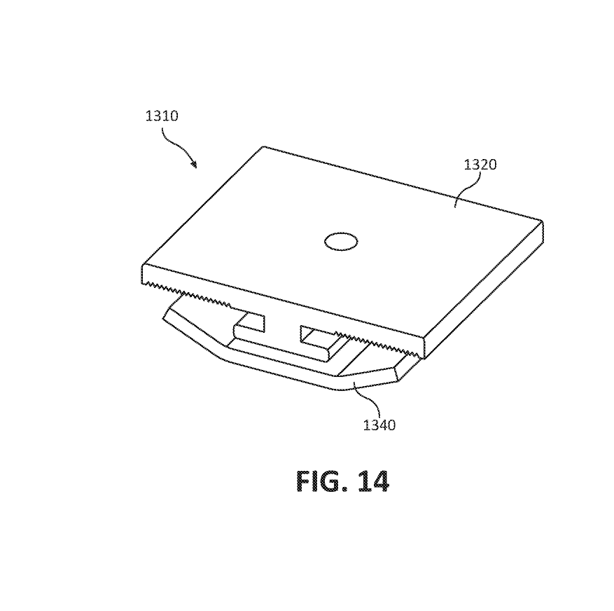

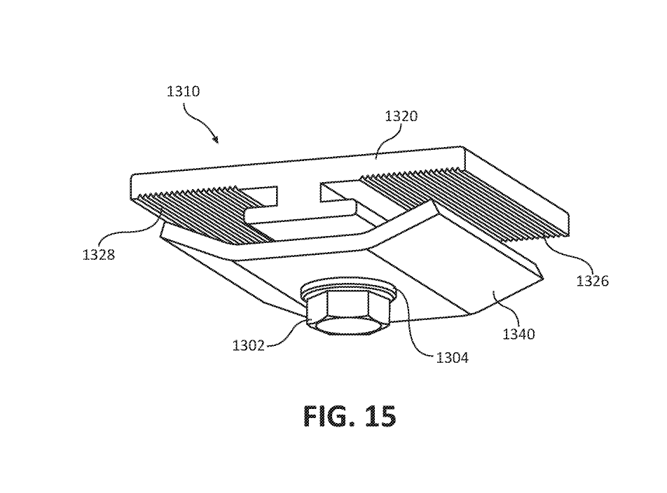

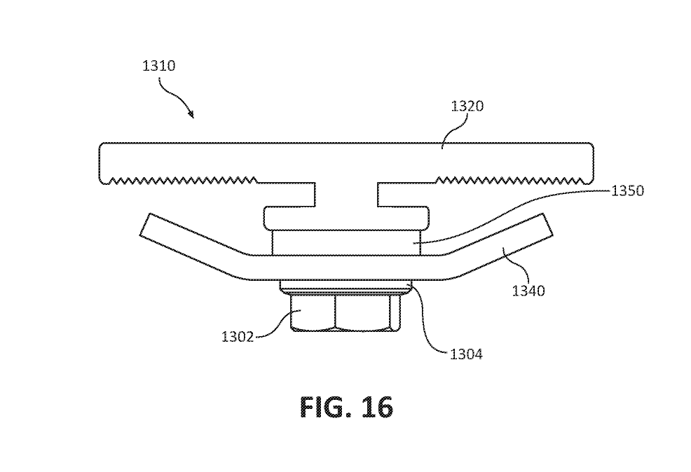

In various embodiments and with reference to FIGS. 13-17, mounting bracket assembly 1310 may include an upper bracket 1320, a lower bracket 1340, a spacer 1350, a fastener 1302, and a washer 1304. Upper bracket 1320 may include a planar upper surface 1322. Upper bracket 1320 may also include a textured or toothed surface 1326 and/or a textured or toothed surface 1328 opposite the upper surface 1322. A “T-shaped” protrusion 1324 can extend downward from textured surfaces 1326 and 1328 (i.e., away from the upper surface 1322). This arrangement forms first channel 1332 between textured surface 1326 and the horizontal portion of T-shaped protrusion 1324, and a second channel 1330 between textured surface 1328 and horizontal portion of the T-shaped protrusion 1324. Upper bracket 1320 may further include an aperture 1321. Aperture 1321 may extend through and be perpendicular to upper bracket 1320. As shown, the aperture 1321 extends through the center of the upper surface 1322. Aperture 1321 may also be a threaded aperture. In this regard, aperture 1321 may be configured to receive, retain, and/or threadably engage fastener 1302.

Lower bracket 1340 may include a central planar panel 1342. When assembled as mounting bracket assembly 1310, lower bracket 1340 may be substantially parallel to upper surface 1322 of upper bracket 1320. Side panels 1346, 1344 may extend upward at an angle from central planar panel 1342 (e.g., approximately between 10 degrees and 90 degrees offset from central planar panel 1342, and, more specifically, approximately 30 degrees offset from central planar panel 1342). When assembled with the upper bracket 1320, the ends of side panels 1346, 1344 can extend towards the respective textured surface 1328, 1326. An aperture 1348 extends through the center of central planar panel 1342. Aperture 1348 may be sized to allow fastener 1302 to pass through aperture 1348. Aperture 1348 may be substantially concentric with and/or may align with aperture 1321. In this regard, fastener 1302 may pass through aperture 1348 to engage the threads defined in aperture 1321.

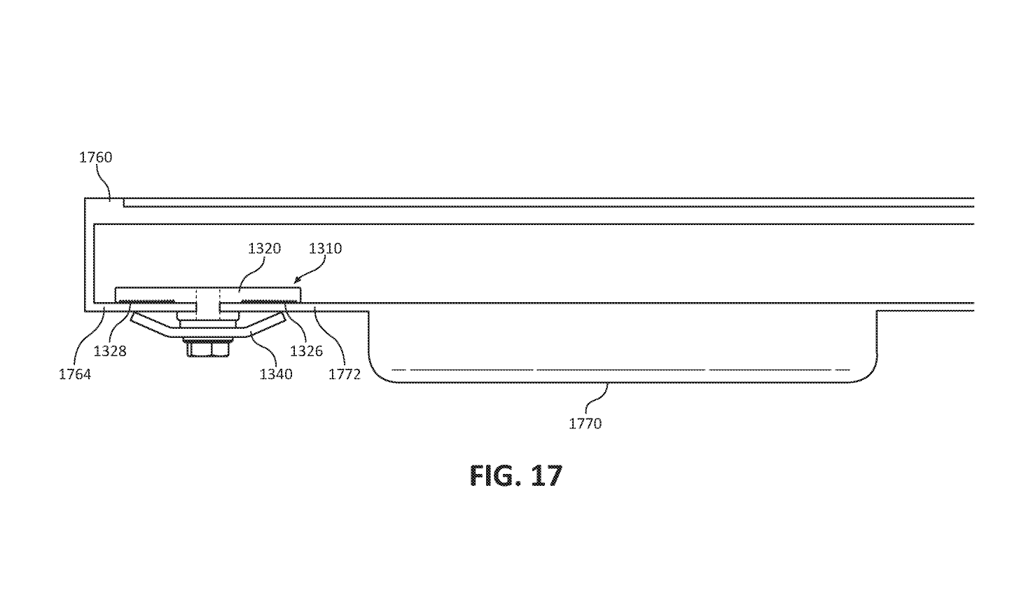

In various embodiments and when assembled, as shown in FIG. 17, fastener 1302 passes through aperture 1348 in lower bracket 1340, an aperture 1352 in the spacer 1350, and threadably engages with the aperture 1321 of the upper bracket 1320. The threading of fastener 1302 presses lower bracket 1340 towards upper bracket 1320, thereby compressing spacer 1350. Spacer 1350 may be elastomeric or otherwise compressible. When compressed, the edge of side panel 1344, in conjunction with the textured surface 1326 can clamp down on a lip 1772 of a container 1770 (similar to the container described above). Lip 1772 and/or container 1770 may be additionally supported by channel 1332. Similarly, when compressed, the edge of side panel 1346, in conjunction with the textured surface 1328 can clamp down on a lip 1764 of a frame 1760 of a solar panel, as described herein. Lip 1764 and/or frame 1760 of the solar panel may be additionally supported by channel 1330.

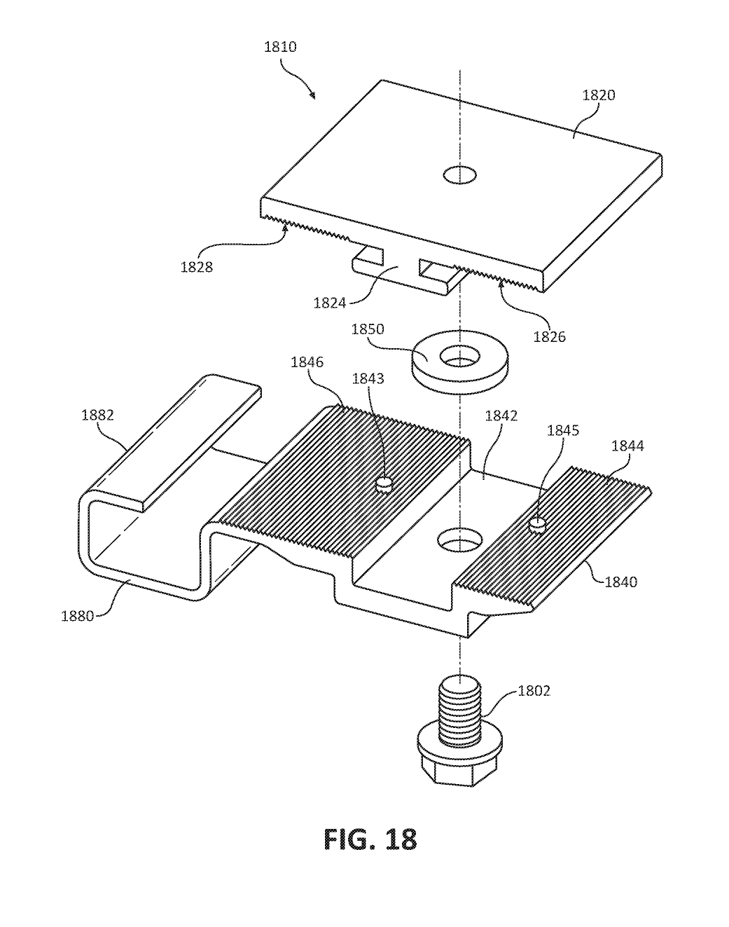

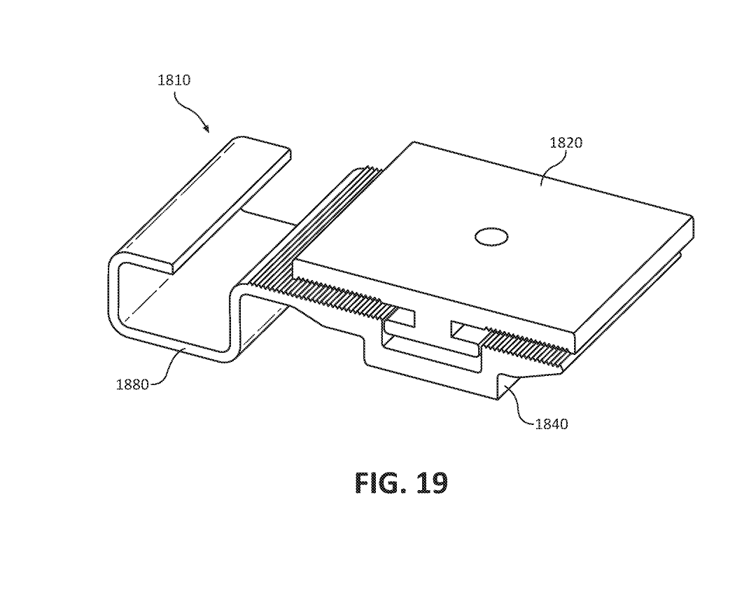

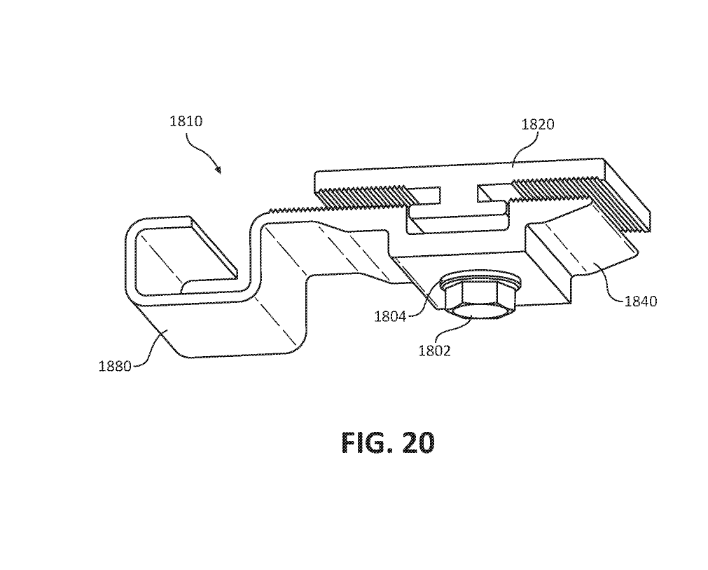

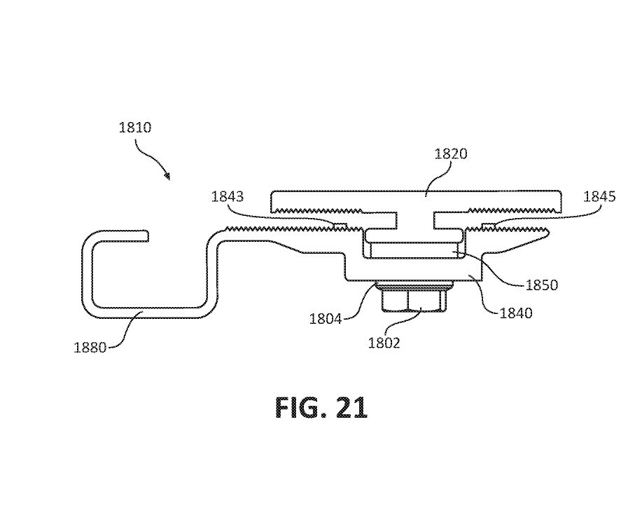

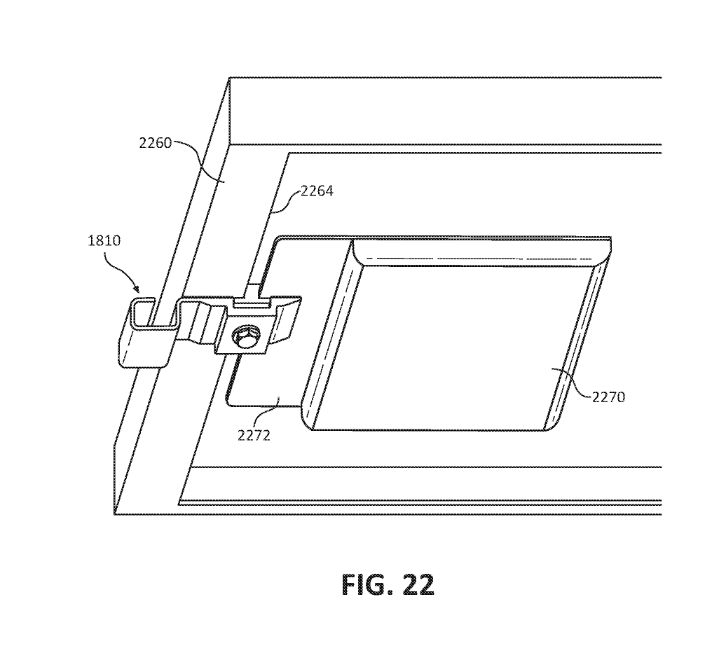

In various embodiments and with reference to FIGS. 18-22, mounting bracket assembly 1810 may be similar to the mounting bracket assembly 1310 shown in FIGS. 13-17 with the differences outlined below. In place of the side panels 1346, 1344, assembly 1810 may include textured or toothed surface 1844, 1846. Textured surface 1844 and textured surface 1846 may have opposing corresponding textured surface 1826 and textured surface 1828 when mounting bracket assembly 1810 is assembled. Textured surface 1844 and textured surface 1846 may be offset from a central planar panel 1842 by a step. The height of the step may be less than the height of a downwardly-depending T-shaped protrusion 1824 by approximately the height of lip 2264 of frame 2260 or container lip 2272 of container 2270. Spacer 1850 may be positioned on a fastener 1802 between central planar panel 1842 and downwardly-depending T-shaped protrusion 1824.

Lower bracket 1840 may include a wire management tray 1880. Wire management tray 1880 may be integrally formed with, operatively coupled to, and/or otherwise attached to lower bracket 1840. Moreover, wire management tray 1880 may include a retention tab 1882. Retention tab 1882 may be configured to retain wiring, cables, and/or the like in wire management tray 1880. Moreover, retention tab 1882 may be position relative to the body portion of lower bracket 1840 to define a channel. In this regard, wires, cables and/or the like may be placed in and retained in a channel defined by wire management tray 1880.

Textured surface 1844 can include cylindrical protrusion 1845 configured to bite into lip 2272 of container 2270 to create an electrically conductive path when assembled. Similarly, textured surface 1846 cab include cylindrical protrusion 1843 configured to bite into the lip 2264 of frame 2260 to create an electrically conductive path when assembled. Cylindrical protrusion 1843 and cylindrical protrusion 1845 may be hardened relative to the rest of the bracket assembly 1810 or relative to the frame lip 2264 and/or container lip 2272. In this regard, cylindrical protrusion 1843 and cylindrical protrusion 1845 may be made from a metal conductive material such as, for example, steel, stainless steel, and/or the like. Cylindrical protrusion 1843 and cylindrical protrusion 1845 can electrically ground container lip 1972, mounting bracket assembly 1810, and/or solar panel frame lip 2264.

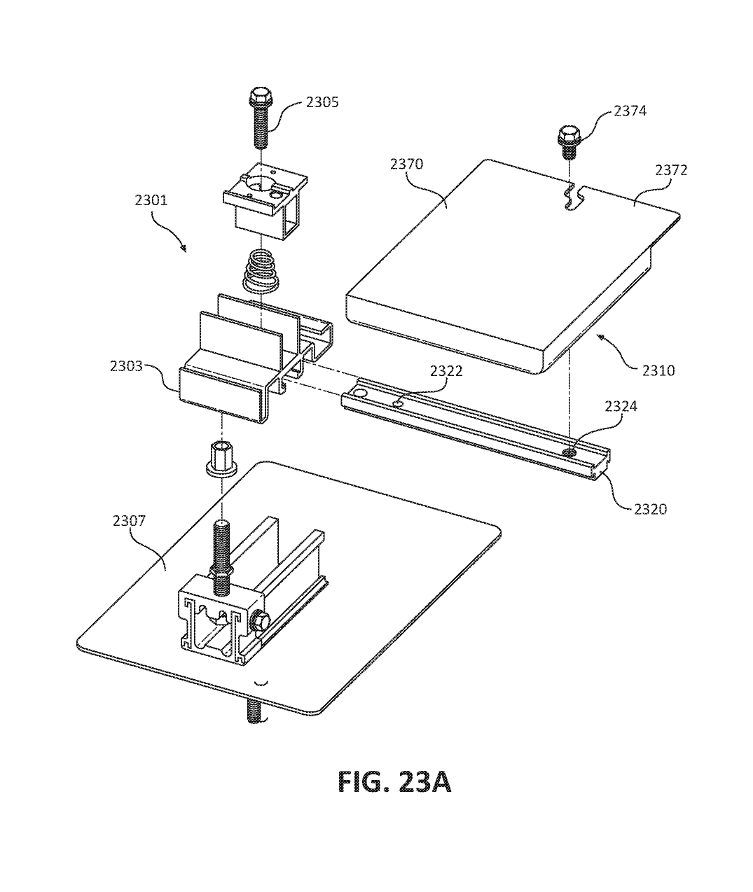

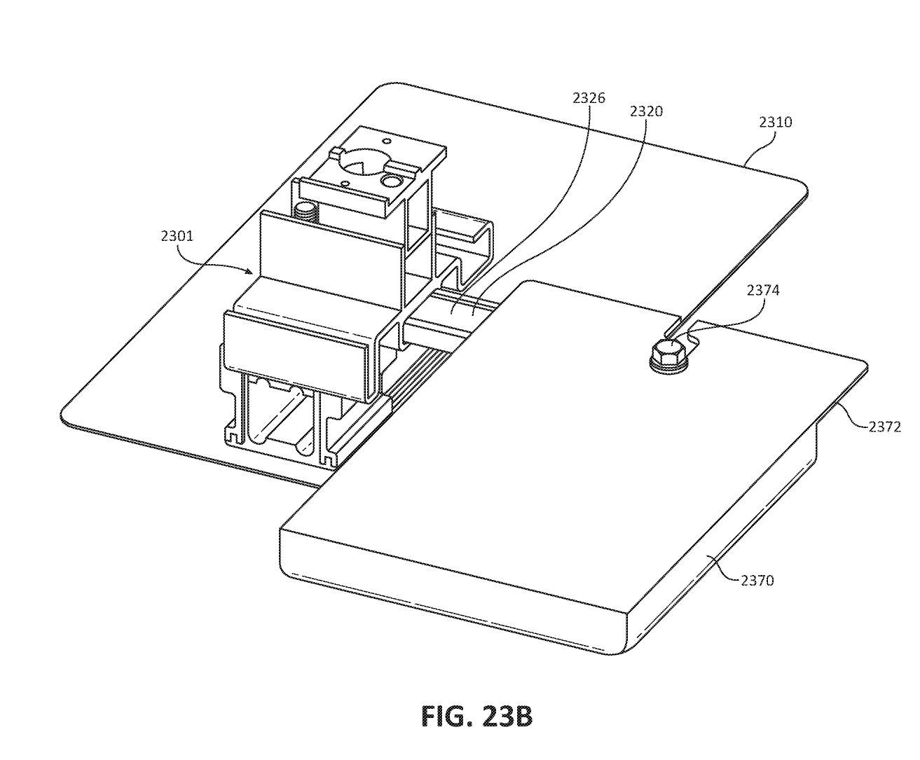

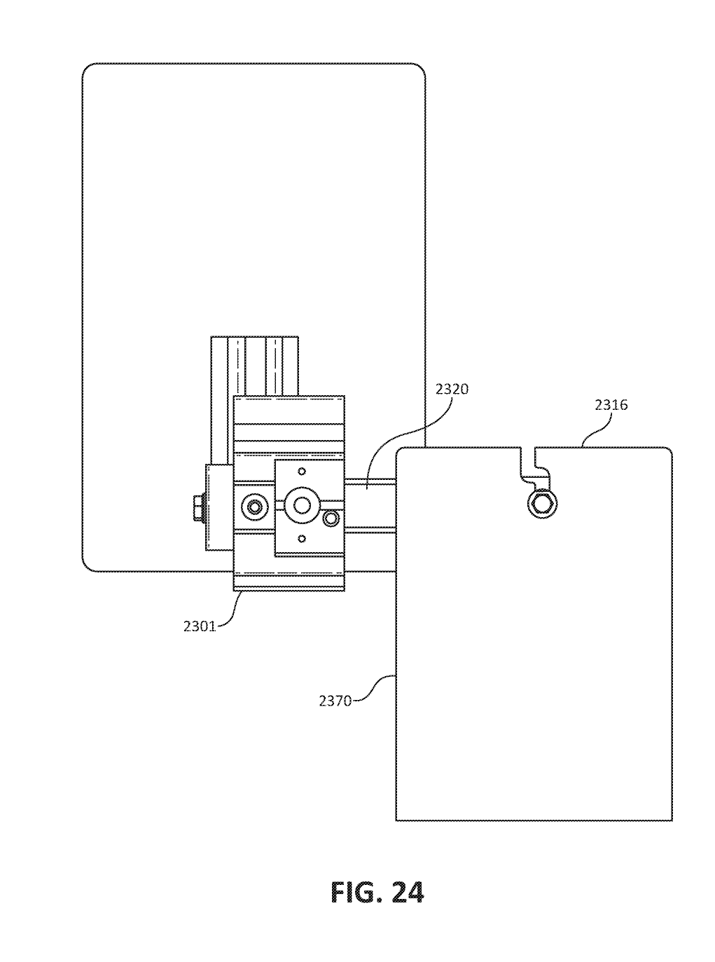

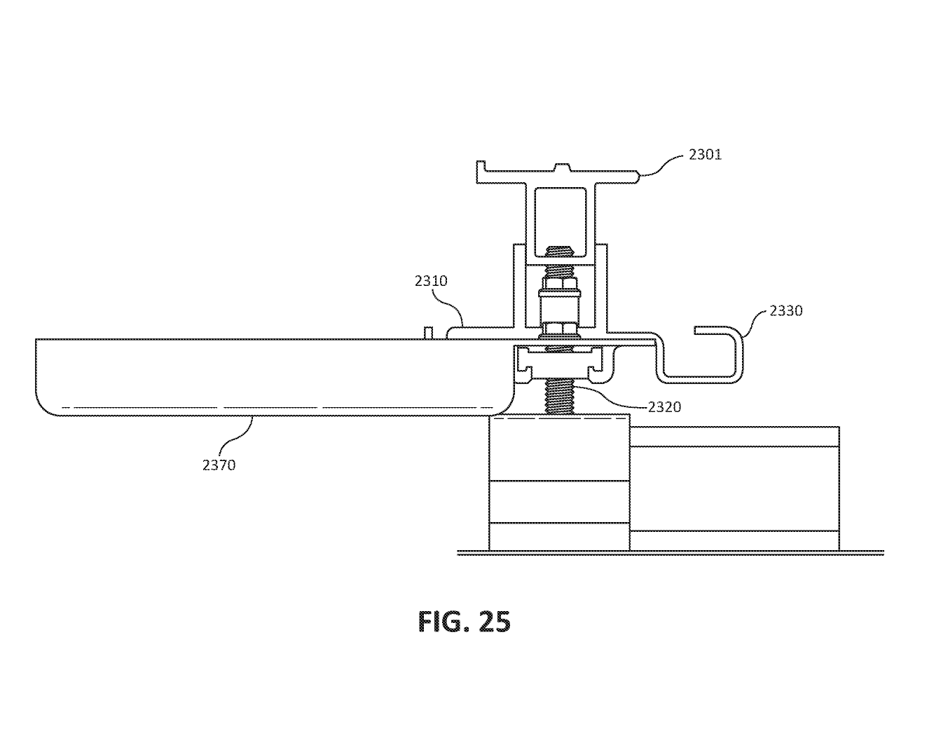

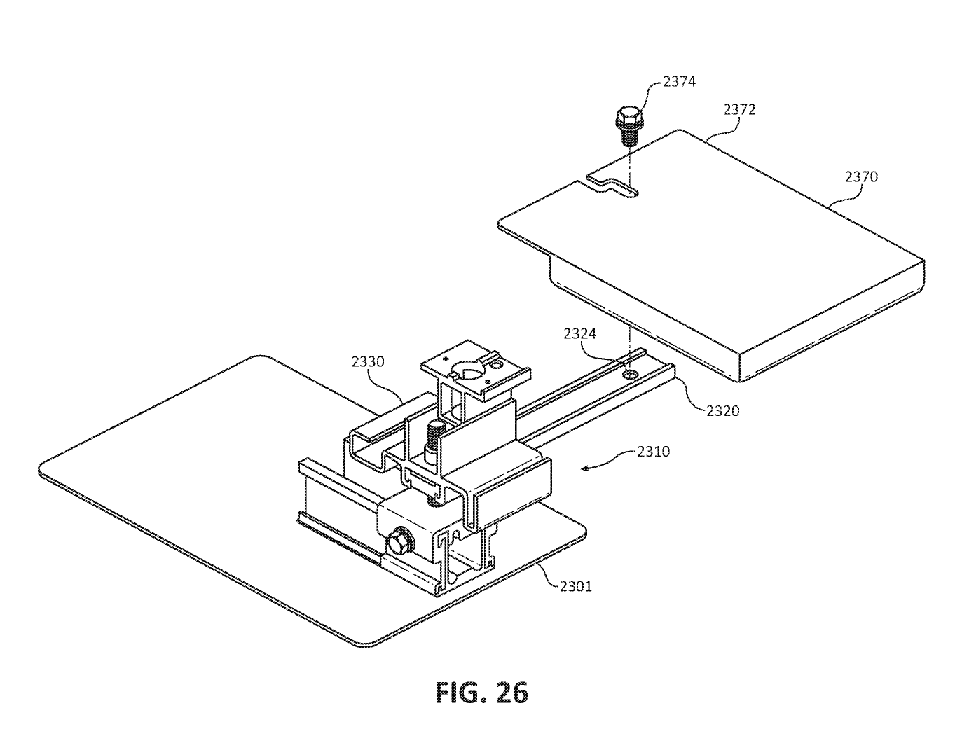

In various embodiments and with reference to FIGS. 23A-26, mounting bracket assembly 2310 may be deployed with, operatively coupled to, and/or installable on a height adjustment bracket 2301. Height adjustment bracket 2301 may be a structure that is configured to interface with a roof, provide a seal (e.g., a water tight seal) and facilitate the affixing of structure to a roof. Height adjustment bracket 2301 may comprise a base structure 2307 including a flashing, one or more mounting brackets, and/or the like. Height adjustment bracket 2301 may also include a body 2303. Body 2303 may be configured to receive and/or interface with mounting bracket assembly 2310. In various embodiments, height adjustment bracket 2301 may be capable of modifying the height of a solar panel. The functionality and structure of height adjustment bracket 2301 is discussed in greater detail in U.S. Publication No. 2015/0288320, the contents of which are incorporated herein by reference for any purpose.

In various embodiments, mounting bracket assembly 2310 may comprise a beam 2320, and a fastener 2374. Beam 2320 may comprise one or more apertures including, for example, aperture 2322, aperture 2324, and/or the like. Beam 2320 may be configured to operatively couple to body 2303 or height adjustment bracket 2301. In this regard, a fastener 2305 may pass through body 2303, and beam 2320 via aperture 2322 to retain beam 2320 to body 2303.

Beam 2320 may have a substantially rectangular shape with an upper surface 2326. Upper surface 2326 may include various indents and protrusions to align or mate with the height adjustment bracket 2301. At one end, beam 2320 may be fixed to height adjustment bracket 2301 (e.g., via a fastener or epoxy, via a snap-fit, formed integrally with the bracket 2301, and/or the like). At the other end, beam 2320 may include an aperture 2324 extending substantially perpendicular to and through the upper surface 2326. Aperture 2324 may be sized to accept a fastener 2374 such as, for example, a bolt. When assembled, the fastener 2374 passes through an opening in the lip 2372 of a container 2370 (e.g., similar to the containers described herein). Fastener 2374 may pass through aperture 2324 in the beam 2320. Aperture 2324 may be threaded to provide a clamping force; alternatively, a nut (not shown) may clamp container 2370 to beam 2320.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A mounting bracket, comprising:
a middle portion comprising a channel and a lip;
a top portion operatively coupled to the middle portion, the top portion comprising a first engagement structure and defining a first aperture; and
a bottom portion operatively coupled to the middle portion,
wherein the mounting bracket is configured to mount a container to a structure, and
wherein the mounting bracket is configured to create a bond path between the container and the structure.

2. The mounting bracket of claim 1, wherein the bottom portion comprises a second engagement structure and defines a second aperture.

3. The mounting bracket of claim 2, wherein the first aperture is substantially concentric with the second aperture.

4. The mounting bracket of claim 1, wherein the first engagement structure is a tooth.

5. The mounting bracket of claim 1, wherein the first engagement structure is a textured surface.

6. The mounting bracket of claim 1, wherein the first engagement structure is a fastener.

7. The mounting bracket of claim 1, wherein the middle portion is operatively coupled to the top portion by a first bend.

8. The mounting bracket of claim 7, wherein the bottom portion is a lip.

9. The mounting bracket of claim 7, wherein the bottom portion is operatively coupled to the middle portion by a second bend.

10. The mounting bracket of claim 9, wherein the bottom portion comprises a second engagement structure.

11. The mounting bracket of claim 10, wherein the second engagement structure is at least one of a tooth, a fastener, or a textured surface.

12. An inverter clip, comprising:
a first member defining a channel and a lip;
a second member operatively coupled to and disposed above the first member, the second member comprising a first tooth and defining a first aperture; and
a third member operatively coupled to and disposed below the first member, the third member comprising a second tooth and defining a second aperture,
wherein the inverter clip is configured to create a bond path between a solar panel and a container.

13. The inverter clip of claim 12, wherein the first member is coupled to the second member by a first bend.

14. The invertor clip of claim 13, wherein the first member is coupled to the third member by a second bend.

15. The invertor clip of claim 14, wherein a portion of the second member extends beyond the second bend.

16. The inverter clip of claim 14, wherein the second bend is disposed between the first bend and the lip.

17. The inverter clip of claim 12, wherein the first member is operatively coupled to the second member by a hinge pin.

18. The inverter clip of claim 12, wherein the first tooth is configured to engage a metal portion of a frame of the solar panel.

19. The inverter clip of claim 12, wherein the first aperture is concentric with the second aperture.

20. The inverter clip of claim 19, wherein a fastener is installable through the first aperture and the second aperture to compress the second member and the third member toward the first member.
